(19) United States
(12) Patent Application Publication
(10) Pub. No.: US 2016/0290159 A1
(43) Pub. Date: Oct. 6, 2016

(54) LIQUID-COOLED TURBINE HOUSING WITH INTERMEDIATE CHAMBER

(71) Applicant: BORGWARNER INC., Auburn Hills, MI (US)

(72) Inventors: Daniel N. WARD, Asheville, NC (US); Michael WALLS, Arden, NC (US)

(21) Appl. No.: 15/035,254

(22) PCT Filed: Nov. 10, 2014
(86) PCT No.: PCT/US14/64772

§ 371 Date: May 9, 2016

Related U.S. Application Data
(60) Provisional application No. 61/903,431, filed on Nov. 13, 2013.

(51) Int. Cl. F01D 25/14; F02B 37/00; F01D 25/12; F01D 5/02; F01D 25/24

(52) U.S. Cl. CPC F01D 25/14; F01D 5/02; F01D 25/24; F01D 25/12; F02B 37/00; F05D 2220/40; F05D 2260/232

(57) ABSTRACT

A turbocharger (10) with a liquid-cooled turbine housing (12) including an intermediate chamber (30) adjacent to the liquid chamber (20) of the turbine housing (12). The intermediate chamber (30) is between the liquid chamber (20) and a turbine housing exducer wall portion (34), partially near the turbine wheel blades. A preferred intermediate chamber (30) is a core that encloses the volute (18) and completely separates and insulates the hot volute (18) from the relatively cool liquid chamber (20). The intermediate chamber (30) may have a passage (40) as an exhaust gas inlet through the turbine housing exducer wall (24) or as an air inlet through the turbine housing (12) for flow into the intermediate chamber (30).

### CROSS-REFERENCE TO RELATED APPLICATION

This application claims priority to and all the benefits of U.S. Provisional Application No. 61/903,431, filed on Nov. 13, 2013, and entitled “Liquid-Cooled Turbine Housing with Intermediate Chamber,” which is incorporated herein by reference.

### BACKGROUND

1. Field of the Disclosure

This disclosure relates to liquid-cooled turbine housings for turbochargers. More particularly, this disclosure relates to an intermediate chamber adjacent to a liquid cooling chamber of the turbine housing.

2. Description of Related Art

Advantages of turbocharging include increased power output, lower fuel consumption, reduced pollutant emissions, and improved transient response. The turbocharging of engines is no longer primarily seen from a high-power performance perspective, but is rather viewed as a means of reducing fuel consumption and environmental pollution on account of lower carbon dioxide (CO₂) emissions. Currently, a primary reason for turbocharging is using exhaust gas energy to reduce fuel consumption and emissions. In turbocharged engines, combustion air is pre-compressed before being supplied to the engine. The engine aspirates the same volume of air-fuel mixture as a naturally aspirated engine, but due to the higher pressure, thus higher density, more air and fuel mass is supplied into a combustion chamber in a controlled manner. Consequently, more fuel can be burned, so that the engine's power output increases relative to the speed and swept volume.

In exhaust gas turbocharging, some of the exhaust gas energy, which would normally be wasted, is used to drive a turbine. The turbine includes a turbine wheel that is mounted on a shaft and is rotatably driven by exhaust gas flow. The turbocharger returns some of this normally wasted exhaust gas energy back into the engine, contributing to the engine's efficiency and saving fuel. A compressor, which is driven by the turbine, draws in filtered ambient air, compresses it, and then supplies it to the engine. The compressor includes a compressor wheel that is mounted on the same shaft so that rotation of the turbine wheel causes rotation of the compressor wheel.

Turbochargers typically include a turbine housing connected to the engine's exhaust manifold, a compressor housing connected to the engine's intake manifold, and often a center housing coupling the turbine and compressor housings together. The turbine housing defines a volute that surrounds the turbine wheel and that receives exhaust gas from the engine. The turbine wheel in the turbine housing is rotatably driven by a controlled inflow of exhaust gas supplied from the exhaust manifold.

Referring to FIG. 1, as an example, water-cooled turbine housings of turbochargers are known where water enters a liquid cooling chamber of the turbine housing to keep the outer shell cool, given that the engine exhaust flowing through the volute is extremely hot. In some configurations, for example, the exhaust gas is about 700 degrees Celsius. The inner walls enclosing the exhaust area need to expand due to the thermal growth from the surrounding high temperatures, but they are constrained from outward expansion by the cooler outer shell structure. Thus, the inner walls must expand internally (e.g., inward) to accommodate the high exhaust temperatures.

Typically, tight clearances are required between the turbine housing and turbine wheel. There is risk that the expanding internal walls in the exducer region of the turbine housing will interfere with, such as rub, the turbine wheel that spins at high speeds. Significant damage to the turbine housing and turbine wheel can result. FIG. 2A shows regions of potential interference (rubbing) on the turbine housing exducer region adjacent to the blades of the turbine wheel. FIG. 2B shows how rub markings may appear within the exducer profile surface of the turbine housing after a turbine wheel rubbed the surface. Similarly, FIG. 2C shows typical rub damage on a turbine wheel that has rubbed on the inner surface of the turbine housing. Once the turbine wheel and turbine housing interfere, the problem can quickly escalate into broken turbine wheel blades or even separation of the turbine wheel from the shaft. Thus, concerns may arise with a turbine wheel interfering with the turbine housing exducer wall of a liquid-cooled turbine housing.

Also, a liquid-cooled turbine housing may reduce thermal efficiency. Relatively cool liquid directly contacting the hot inner volute wall can reduce thermal efficiency due to exhaust gas heat energy dissipating into the liquid.

### SUMMARY

This disclosure relates to turbochargers with liquid-cooled turbine housings with an intermediate chamber, such as an additional exhaust chamber, adjacent to the liquid chamber of the turbine housing. Such an intermediate chamber insulates the hot volute from the relatively cool liquid chamber.

Thus, the turbine housing with an intermediate chamber adjacent to the liquid chamber can address concerns with thermal strains induced within the turbine housing, which can cause the exducer region to constrict instead of expand with high exhaust temperatures and any resulting failures from a turbine wheel contacting the turbine housing exducer wall.

Also, the liquid-cooled turbine housing with an intermediate chamber adjacent to the liquid chamber may improve efficiency of the turbine stage by keeping the exhaust gas heat energy from dissipating into the liquid in the liquid chamber. Relatively cool liquid in the liquid chamber does not contact all or part of the hot inner volute wall so thermal efficiency is not lost with exhaust gas heat energy dissipating into the liquid.

In summary, the benefits of a turbine housing with an intermediate chamber between the liquid chamber and the exducer region of the turbine housing include reduced thermal strains and improved thermal efficiency.

### BRIEF DESCRIPTION OF THE DRAWINGS

Advantages of the present disclosure will be readily appreciated as the same becomes better understood by reference to the following detailed description when considered in connection with the accompanying drawings wherein:

FIG. 1 is a cross-sectional view of a prior art turbine side of a turbocharger with a liquid-cooled turbine housing;

FIG. 2A is an example of a cross-section of a prior art liquid-cooled turbine housing showing damage to the exducer profile surface after a turbine wheel rubbed the surface;

FIG. 2B is an enlarged portion of the turbine housing of FIG. 2A;

FIG. 2C is an example of typical damage to a turbine wheel that has rubbed on the inner surface of the turbine housing;

FIG. 3 is a cross-sectional view of a liquid-cooled turbine housing including an intermediate chamber adjacent to the liquid chamber that totally encloses the volute wall with an optional passage that allows exhaust gas into the intermediate chamber;

FIG. 4 is a cross-sectional view of an alternative embodiment liquid-cooled turbine housing including an intermediate chamber adjacent to the liquid chamber that totally encloses the volute core wall with an optional passage allowing air into the intermediate chamber;

FIG. 5 is a cross-sectional view of another alternative embodiment liquid-cooled turbine housing with an intermediate chamber that partially encloses the volute; and

FIG. 6 is a cross-sectional view of another alternative embodiment liquid-cooled turbine housing with an intermediate chamber that partially encloses the volute with a simple casting.

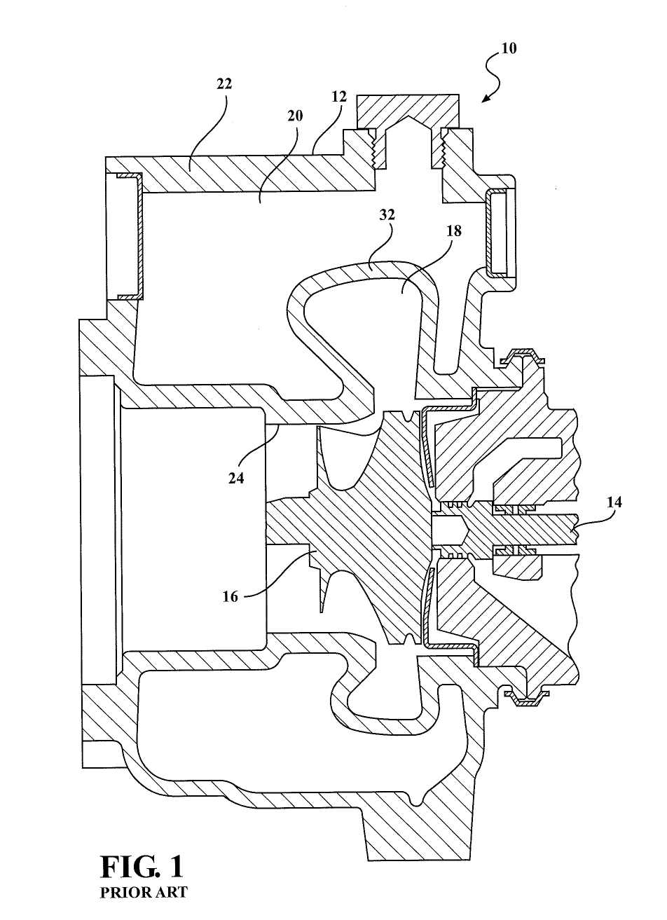

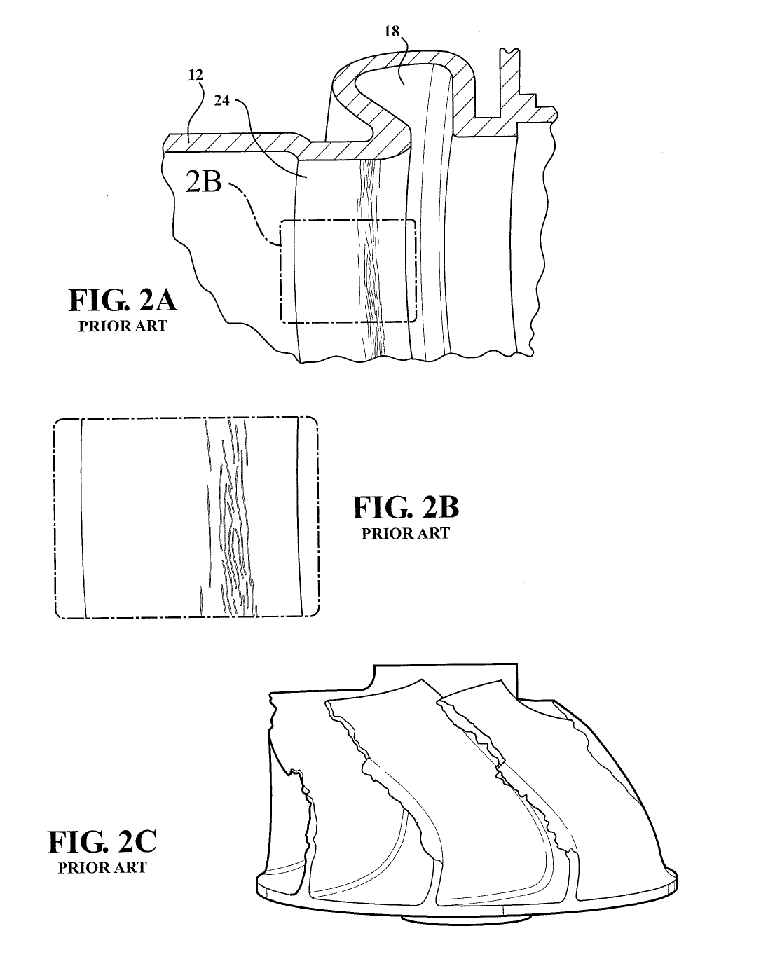

### DETAILED DESCRIPTION OF THE EMBODIMENTS

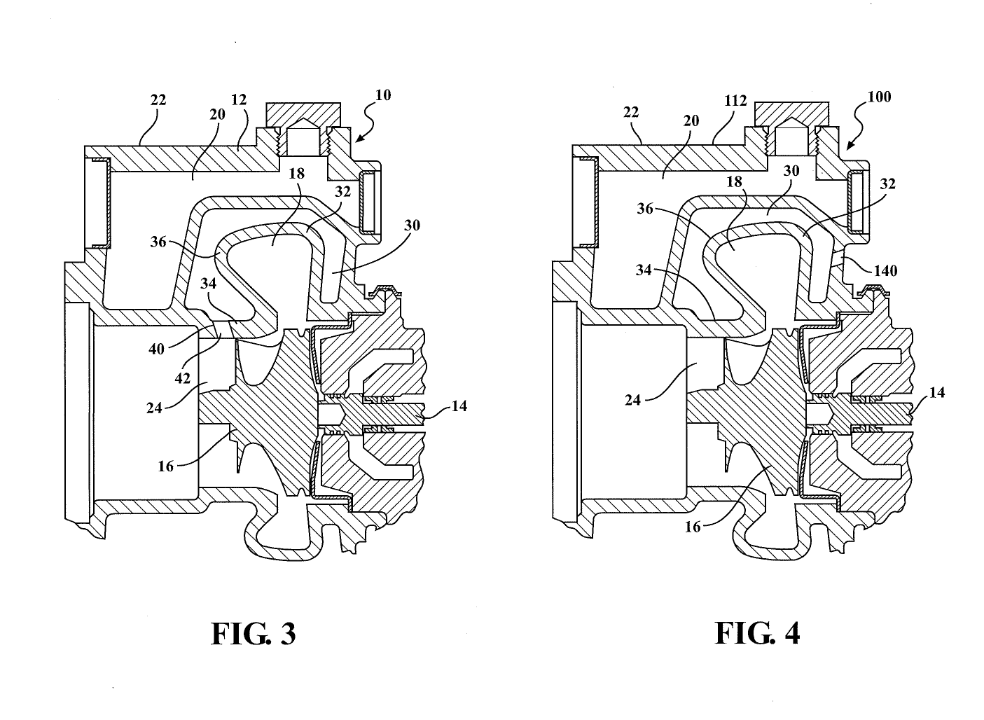

Referring to FIG. 3, a turbocharger 10 includes a compressor wheel (not shown) in a compressor housing (not shown) that is rotatably driven via a rotatable shaft 14 by a turbine wheel 16 in a turbine housing 12. The turbine housing 12 is a liquid-cooled turbine housing 12, and includes an exhaust gas inlet (not shown) configured to be connected to an exhaust manifold of an engine. The turbine housing 12 includes an exhaust gas outlet (e.g., an exducer) 24, and a volute 18. The volute 18 defines a main chamber that surrounds the turbine wheel 16, and directs hot exhaust gas toward blades of the turbine wheel 16. The turbine housing 12 further includes an outer shell 22. A liquid chamber 20, for example a water core, is defined between the outer shell 22 and an inner wall 36 that includes a wall portion 32 forming the volute 18 and a wall portion 34 forming the exducer 24. Thus, the liquid chamber 20 is adjacent to an outer shell 22 of the turbine housing 12.

The turbocharger 10 with a liquid-cooled turbine housing 12 has an intermediate chamber 30 disposed between the liquid chamber 20 and the inner wall 36, including the exducer wall portion 34 and the volute wall portion 32. The turbine housing exducer region is preferably completely adjacent to the intermediate chamber 30 to help control thermal expansion of the exducer wall portion 34 and to minimize thermal strains within the turbine housing 12. The intermediate chamber 30 totally encloses the volute 18. The intermediate chamber 30 completely separates and insulates the entire hot volute 18 (with hot exhaust gas) from the relatively cool liquid chamber 20, which can improve efficiency of the turbine stage by keeping the exhaust gas heat energy from dissipating into the liquid in the liquid chamber 20. Relatively cool liquid of the liquid chamber 20 does not contact the volute wall portion 32 so thermal efficiency is not lost with exhaust gas heat energy dissipating into the liquid. This improves turbine efficiency as turbine exhaust gases remain at the highest possible temperature before entering the turbine wheel 16.

The intermediate chamber 30 as in FIG. 3 may optionally have a passage 40 through the exducer wall portion 34 that allows exhaust gas into the intermediate chamber 30. The exhaust gas passage 40 may be a slot 42 through the exducer wall portion 34, or alternatively may extend around circumference of the exducer wall portion 34 to permit flow of exhaust gas into the intermediate chamber 30. The slot 42, whether partially or fully around the exducer wall portion 34 may reduce stiffness of the volute wall portion 32 and may increase the temperature in the intermediate chamber 30. The volute wall portion 32 can then expand and contract as necessary, and the thermal stresses are reduced in the exducer wall portion 34 directly enclosing the turbine wheel 16. This configuration therefore minimizes the inward thermal growth of the turbine housing exducer wall portion 34.

Referring to FIG. 4, an alternative turbocharger 100 is similar the turbocharger 10 described above with respect to FIG. 3, and like reference numbers are used to refer to like parts. The turbocharger 100 includes a liquid-cooled turbine housing 112 with an intermediate chamber 30 adjacent to the liquid chamber 20. The intermediate chamber 30 is disposed between the liquid chamber 20 and the inner wall 36, including the exducer wall portion 34 and the volute wall portion 32, and totally encloses the volute 18. The turbocharger 100 includes a passage 140 through the outer wall of the turbine housing 112, allowing air into the intermediate chamber 30. The passage 140 passing through the turbine housing 112 serves as an air inlet and allows flow of ambient air as the intermediate gas in the intermediate chamber 30 between the liquid chamber 20 and volute 18.

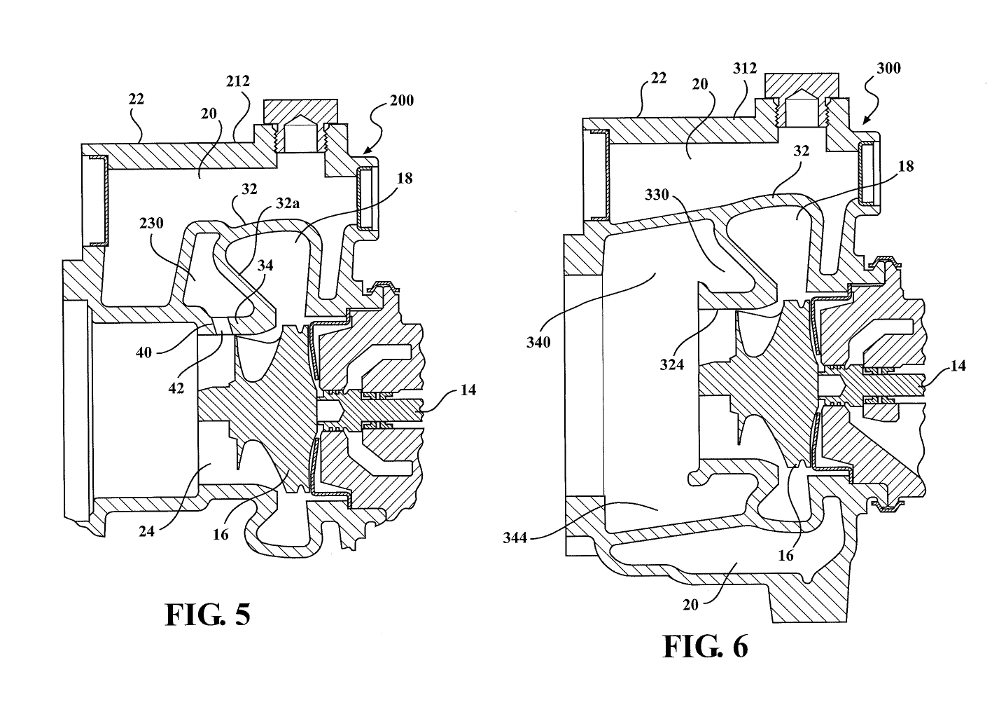

Referring to FIG. 5, another alternative turbocharger 200 is similar the turbocharger 10 described above with respect to FIG. 3, and like reference numbers are used to refer to like parts. The turbocharger 200 includes a liquid-cooled turbine housing 212 with an intermediate chamber 230 adjacent to the liquid chamber 20. The intermediate chamber 230 partially encloses the volute 18 and is disposed between the liquid chamber 20 and the exducer wall portion 34 and at least a portion 32a of the volute wall portion 32. The intermediate chamber 230 insulates a portion of volute 18 from the liquid chamber 20, but the intermediate chamber 230 only partially encloses the volute wall portion 32.

The configuration of FIG. 5 may be easier to manufacture than some of the previously described embodiments due to the reduced complexity of the core design, however, this configuration will not be as thermally efficient given that some of the cool liquid is directly contacting the volute wall portion 32. While a sand core could be kept intact in a closed intermediate core of the intermediate chamber 230, it may be desirable to machine a slot or passage 40 either partially or fully around the exducer wall portion 34 downstream of the position of the turbine wheel 16 to reduce the stiffness of the volute wall portion 32 and to increase the temperature in the intermediate chamber 230. This configuration is primarily concerned with ensuring that the turbine wheel 16 does not interfere with the turbine housing's exducer wall portion 34, while being less concerned with the reduced thermal efficiency.

Referring to FIG. 6, another alternative turbocharger 300 is similar the turbocharger 10 described above with respect to FIG. 3, and like reference numbers are used to refer to like parts. The turbocharger 300 includes a liquid-cooled turbine housing 312 with an intermediate chamber 330 that partially encloses the volute 18 with a less complex casting. This allows for easier sand shake-out after parts are cast. This intermediate chamber 330 may be integrated into an exhaust core with a substantially open passage 340. The intermediate chamber 330 largely open to the exhaust core still creates the expandable annular exducer wall portion 334. An optional circumferential passage 344 extends fully around the exducer wall portion 334. The circumferential passage 344 is disposed downstream of the turbine wheel 16 and allows exhaust gas into the intermediate chamber 330. The circumferential passage 344 may increase the temperature in the intermediate chamber 30.

The formation of cores in castings and cost of casting may also dictate the embodiment as well as benefits of reduced thermal strains and improved thermal efficiency. For more complex cores, the intermediate sand core could be kept intact within the casting or a thin-shell ceramic or other insert could be used in the mold during the pour. In all disclosed castings, the intermediate chamber 30 separates the exducer wall portion 34 from the liquid chamber 20.

The invention is described in an illustrative manner, and it is to be understood that the terminology used is intended to be in the nature of words of description rather than limitation. Many modifications and variations of the present invention are possible in light of the above teachings. It is, therefore, to be understood that within the scope of the appended claims, the invention may be practiced other than as specifically enumerated in the description.

What is claimed is:

1. A liquid-cooled turbine housing (12) configured to cool a turbine section of a turbocharger (10), the turbine housing (12) comprising
a liquid chamber (20) adjacent to an outer shell (22),
an intermediate chamber (30) between the liquid chamber (20) and a turbine housing exducer wall portion (34).

2. The turbine housing (12) of claim 1 wherein the intermediate chamber (30) has an exhaust gas passage (40) through the turbine housing exducer wall portion (34).

3. The turbine housing (12) of claim 1 wherein an exhaust gas passage (40) extends fully around the circumference of the turbine housing exducer wall portion (34).

4. The turbine housing (12) of claim 1 wherein the intermediate chamber (30) has an air-inlet passage (40) through the turbine housing (12) configured to provide a flow of air into the intermediate chamber (30).

5. The turbine housing (12) of claim 1 wherein the intermediate chamber (30) encloses a turbine volute wall portion (32).

6. A turbocharger (10) comprising:
a turbine wheel (16) on a rotatable shaft (14); and
a liquid-cooled turbine housing (12), the turbine housing (12) including
a volute (18) surrounding the turbine wheel (16);
a liquid chamber (20) adjacent to an outer shell (22) of the turbine housing (12);
an exducer wall portion (34) adjacent to a portion of the turbine wheel (16); and
an intermediate chamber (30) disposed between the liquid chamber (20) and the exducer wall portion (34), the intermediate chamber (30) insulating at least of a portion of the volute (18) from the liquid chamber (20).

7. The turbocharger (10) of claim 6 wherein the intermediate chamber (30) totally encloses the volute (18) and completely separates the volute (18) from the liquid chamber (20).

8. The turbocharger (10) of claim 6 wherein the intermediate chamber (30) includes a passage (40) through the exducer wall portion (34) configured to permit a flow of exhaust gas into the intermediate chamber (30).

9. The turbocharger (10) of claim 8 wherein the passage (40) is a slot (42) through the exducer wall portion (34).

10. The turbocharger (10) of claim 6 wherein the intermediate chamber (30) includes a passage (40) that extends circumferentially around the exducer wall portion (34) downstream of the turbine wheel (16).

11. The turbocharger (10) of claim 6 wherein the intermediate chamber (30) includes an air-inlet passage (40) through the turbine housing (12) configured to permit a flow of air into the intermediate chamber (30).
